(19) United States
(12) Patent Application Publication
(10) Pub. No.: US 2019/0078559 A1
(43) Pub. Date: Mar. 14, 2019

(54) IGNITER SYSTEM FOR USE WITH ELECTRIC PROPULSION SYSTEMS

(71) Applicant: Purdue Research Foundation, West Lafayette, IN (US)

(72) Inventors: Alexey Shashurin, West Lafayette, IN (US); Omar Gabriel Dary, West Lafayette, IN (US); Yunping Zhang, West Lafayette, IN (US)

(73) Assignee: Purdue Research Foundation, West Lafayette, IN (US)

(21) Appl. No.: 16/128,658

(22) Filed: Sep. 12, 2018

Related U.S. Application Data
(60) Provisional application No. 62/558,851, filed on Sep. 14, 2017.

(51) Int. Cl. F03H 1/00; H05H 1/24

(52) U.S. Cl. CPC F03H 1/0018; B64G 1/405; H05H 2001/2412; H05H 1/2406

(57) ABSTRACT

An ignitor subsystem for use in an electric propulsion system is disclosed. The igniter subsystem includes an igniter, which includes a first electrically conducting electrode, a second electrically conducting electrode, and an electrically insulating layer sandwiched between the first and the second electrically conducting electrodes, and a voltage pulse generator electrically coupled to the first and the second electrically conducting electrodes and is adapted to generate a plurality of pulses each with sufficient voltage to cause a breakdown of the electrically insulating layer, thus causing an avalanche of electrons from one of the first and the second electrically conducting electrodes to the other, the voltage pulse generator is further adapted to limit energy transferred to the igniter in each of the plurality of pulses so as to minimize damage to the igniter.

### CROSS-REFERENCE TO RELATED APPLICATIONS

The present patent application is related to and claims the priority benefit of U.S. Provisional Patent Application Ser. No. 62/558,851 filed Sep. 14, 2017, the entirety of contents of which is hereby incorporated by reference into the present disclosure.

### TECHNICAL FIELD

The present disclosure generally relates to electric propulsion systems, and in particular, to igniters in such systems.

### BACKGROUND

This section introduces aspects that may help facilitate a better understanding of the disclosure. Accordingly, these statements are to be read in this light and are not to be understood as admissions about what is or is not prior art.

An electric propulsion system operates on the basis of providing a tiny amount of thrust with each activation by ejecting ions from a spacecraft at very high rate of speed. These systems can be used in a variety of spacecrafts such as satellites, interplanetary exploration vessels, and likely someday deep space spacecrafts. By some estimates, by 2013 over 200 spacecrafts operated based on electric propulsion systems. These systems are different than the traditional chemical propulsions systems, in which a tremendous mass of fuel and oxidizing agent are used to provide a large amount of thrust for a short duration of time. For example, in the Falcon Heavy engine 400 of the 550 tons is simply the fuel mixture, majority of which burn in less than 3 minutes, ejecting gases at about 5 km/s, resulting in fuel efficiency of about 35%. In another example, the main hydrogen/oxygen engine on NASA's space shuttle produced a thrust of about 2 MN and had a mass flow rate of approximately 700 kg s⁻¹. In that engine, combustion products were expelled at velocity of 2.8 km/s.

Similarly, in an electric propulsion system, the ejected ions act as a propellant in the same way as the combustion products of a chemical rocket. However, that is where the similarities end. In contract to a chemical engine, the amount of thrust produced by an EP system is very small compared to that of a chemical rocket. For example, the Boeing® 702 EP system produces a thrust of 165 mN and has a mass flow rate of approximately 4.4 mg/s. The ions exit the engine at an ejection velocity of about 37.5 km/s. In some other ion engines, an ejection speed of about 90 km/s can be reached. The very high velocity with which ions are ejected from the ion engine of an EP system means that the amount of thrust per unit mass flow rate is very large compared to that of a chemical rocket leading to a much higher efficiency rating.

With the advent of the electric propulsion systems, there has been a rapid increase of interest in small satellites, such as CubeSats, which are usually launched as secondary payloads and are useful as instruments of targeted investigations to augment the capabilities of large space missions and enable new kinds of measurements. With an on-board propulsion system, CubeSats are able to achieve orbital maneuvers, formation flying, constellation maintenance and precise attitude control. Depending on the mechanism of acceleration, traditional electric propulsion systems are generally divided into three categories: electrothermal, electrostatic, and electromagnetic.

One of the central parts of electrical propulsion systems is the ignitor subsystem, which is required for the discharge initiation. Generally, there are many different methods to ignite a discharge in vacuum, among which are initiation using gas injection, high voltage breakdown, mechanical actuators for drawn arcs, fuse wire explosion, etc. Other methods such as the triggerless method use vaporization of conductive coating between the anode and cathode. All these triggering mechanisms operate by providing seed plasma required to bridge the electrodes and initiate the discharge. However, a robust and compact ignitor which can reliably trigger the discharge in the electrical propulsion system throughout the entire operational lifetime remain elusive. This is due to the challenge that while the triggering methods considered above are capable of discharge initiation, they have significant drawbacks from the prospective of propulsion applications. Indeed, the necessity to carry a gas storage tank for the gas injection triggering methods, and the need to utilize a high voltage source in high voltage breakdown techniques are adding to weight and complexity of the ignitor. The triggerless method requires relatively high current (about 200 A) and long duration (about 5 ms) for reliable re-deposition of the conducting film on the insulating electrode separator and operation up to 10⁶ pulses. As a result, the ignitors of the prior art suffer from repetitive triggering events after relatively low number (10,000-60,000) of cycles.

In one approach a surface flashover is used as an electrode assembly to generate the necessary ionization. In the surface flashover approach, two electrodes are separated by an insulating layer and the breakdown over the insulating surface is initiated at application of high voltage that exceeds the breakdown threshold V_{br}. To be effective, high voltage holdoff capability is desired for these devices, and surface flashover and subsequent breakdown are thus seen as undesirable effects. As a result, the surface flashover phenomenon was studied from the perspective of the ultimate goal to reduce the probability of these breakdown events by increasing the holdoff voltage capability of the device.

Therefore, surface flashover was studied thoroughly by the community interested in the high voltage vacuum devices. This classic flashover is associated with overheating of the flashover electrode assembly and permanent damage to the assembly after relatively low number (<10³) of flashover events due to high current arcs developing in the assembly during the flashover process. These limitations on ignition cycles have hampered the use of flashover-based technologies as successful igniters.

Therefore, there is an unmet need for a novel igniter in the electric propulsion systems that can be used in millions of ignition cycle without degradation.

### SUMMARY

An ignitor subsystem for use in an electric propulsion system is disclosed. The igniter subsystem includes an igniter. The igniter includes a first electrically conducting electrode, a second electrically conducting electrode, and an electrically insulating layer sandwiched between the first and the second electrically conducting electrodes. The igniter subsystem also includes a voltage pulse generator electrically coupled to the first and the second electrically conducting electrodes and is adapted to generate a plurality of pulses each with sufficient voltage to cause a breakdown of the electrically insulating layer, thus causing an avalanche of electrons from one of the first and the second electrically conducting electrodes to the other. The voltage pulse generator is further adapted to limit energy transferred to the igniter in each of the plurality of pulses so as to minimize damage to the igniter.

An electric propulsion system is also disclosed. The propulsion system includes an igniter system which includes an igniter. The igniter includes a first electrically conducting electrode, a second electrically conducting electrode, and an electrically insulating layer sandwiched between the first and the second electrically conducting electrodes. The igniter also includes a voltage pulse generator electrically coupled to the first and the second electrically conducting electrodes and is adapted to generate a plurality of pulses each with sufficient voltage to cause a breakdown of the electrically insulating layer, thus causing an avalanche of electrons from one of the first and the second electrically conducting electrodes to the other thereby generating a cloud of plasma near the igniter. The voltage pulse generator is further adapted to limit energy transferred to the igniter in each of the plurality of pulses so as to minimize damage to the igniter. The propulsion system also includes a burner disposed to receive and ignite the cloud of plasma and eject the burned plasma at high rate of speed out of the burner.

A method of generating plasma for an electric propulsion system is also disclosed. The method includes providing a plurality of voltage pulses to an igniter by a voltage pulse generator. The igniter includes a first electrically conducting electrode, a second electrically conducting electrode, and an electrically insulating layer sandwiched between the first and the second electrically conducting electrodes. The voltage pulse generator is electrically coupled to the first and the second electrically conducting electrodes and is adapted to generate a plurality of pulses each with sufficient voltage to cause a breakdown of the electrically insulating layer, thus causing an avalanche of electrons from one of the first and the second electrically conducting electrodes to the other. The voltage pulse generator is further adapted to limit energy transferred to the igniter in each of the plurality of pulses so as to minimize damage to the igniter.

### BRIEF DESCRIPTION OF DRAWINGS

FIG. 1 is a cross sectional view of an electrode assembly of an igniter according to the present disclosure, including two electrically conducting electrodes and an electrically insulating layer sandwiched therebetween, to be used in an electric propulsion system.

FIG. 2A is a schematic of an excitation system according to the present disclosure for exciting the electrode assembly of FIG. 1.

FIG. 2B is a schematic of a test setup for testing the electrode assembly of FIG. 1.

FIG. 2C is a graph of breakdown voltage of the electrically insulating layer of the electrode of FIG. 1 vs. number of flashover cycles.

FIG. 2D is the same graph as FIG. 2C, zoomed in between 0 and 2000 flashover cycles.

FIG. 2E is a photograph of the electrode assembly of FIG. 1 after 1.5 million cycles.

FIG. 3A is a complex graph of current and voltage vs. time during a flashover cycle, showing various time stamps (t1, t2, t3, and t4).

FIG. 3B is a series of photographs corresponding to the timeslots shown in FIG. 3A (i.e., t1, t2, t3, and t4).

FIG. 4A is a schematic model representation of the electrode assembly without plasma being generated.

FIG. 4B is a schematic model representation of the electrode assembly with plasma being generated.

FIG. 5A is graph of current vs. time showing start of a flashover cycle, when the energy input is limited to 0.35 mJ.

FIG. 5B is graph of current vs. time showing start of a flashover cycle, when the energy input is limited to 5 mJ.

FIG. 6A is a schematic of an assembly for testing the electrode assembly shown in FIG. 1, whereby an additional anode was placed at the distance d from the electrode assembly.

FIG. 6B is a photograph of the test setup of FIG. 6A, showing the dimension d.

FIG. 7A is a complex graph of current of igniter assembly and current through an additional anode circuit shown in FIG. 6A, when the energy input in the igniter is limited to 0.73 mJ.

FIG. 7B is a complex graph of current of igniter assembly and current through an additional anode circuit shown in FIG. 6A, when the energy input in the igniter is limited to 0.39 mJ.

### DETAILED DESCRIPTION

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

In the present disclosure, the term “about” can allow for a degree of variability in a value or range, for example, within 10%, within 5%, or within 1% of a stated value or of a stated limit of a range.

In the present disclosure, the term “substantially” can allow for a degree of variability in a value or range, for example, within 90%, within 95%, or within 99% of a stated value or of a stated limit of a range.

A novel flashover igniter is disclosed for use in electric propulsion systems that can be used in millions of ignition cycle without degradation. The flashover phenomenon typically suffers from a breakdown phase wherein when a high voltage is applied to an insulator within an electrode assembly, the insulator breaks down causing an arc. The break down phase is independent of pressure in the ranges of 5×10⁻³ Torr to 10⁻⁷ Torr. Typically, surface flashover can be broken down in a three phases. In the first phase which lasts for about 10 ns, electrons are emitted from the cathode. In phase 2, which lasts about 100 ns to about 400 ns, there is a breakdown of the insulator which results in an electron emission avalanche. During the third phase, which can last more than about 100 ns (e.g., 100 ns-400 ns) desorption of gases from the insulator surface occurs, resulting in a Townsend breakdown which develops in desorbed gases causing high current arc of greater than 10-100 Amperes. The third phase results in considerable damage that has limited the use of these igniters for the number of cycles that are needed in an electric propulsion system. The novel arrangement of the present disclosure is based in a system that limits the energy provided to the electrodes igniter so that the high-current of phase 3 of the surface flashover is shorten/eliminate to thereby reduce/eliminate the damage to the flashover electrode assembly, making it possible for use as an ignitor for the discharge in propulsion system. To this end, the arrangement described herein modifies the traditional surface flashover by significant reduction of the energy of the individual flashover event in order to achieve large number of flashovers with the same electrode assembly without significant damage or degradation to the assembly. This approach is referred to herein as Low Energy Surface Flashover (LESF).

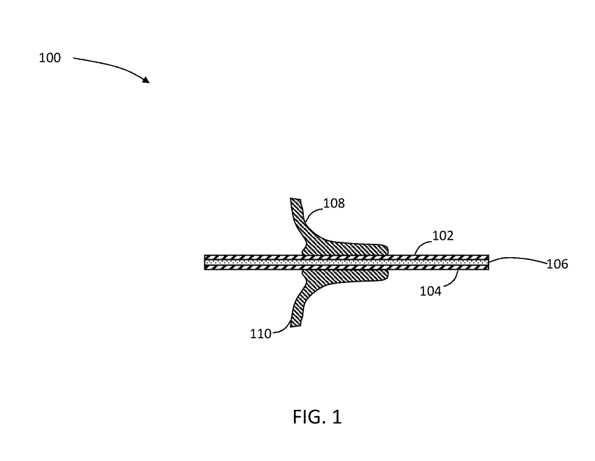

Referring to FIG. 1, a cross-sectional schematic of an electrode assembly 100 is shown, according to the present disclosure. The electrode assembly includes a first electrically conducting member 102, a second electrically conducting member 104, and an electrically insulating member 106 sandwiched therebetween. The electrode assembly 100 further includes lead assemblies 108 and 110, electrically coupled to the first electrically conducting member 102 and the second electrically conducting member 104, respectively. According to one embodiment, the first and second electrically conducting members 102 and 104 are about 10 mm×10 mm×0.5 mm copper electrodes bonded to a non-porous alumina ceramic sheet (electrically insulating member) that is about 0.635 mm thick with a low vapor pressure epoxy. Electrode materials can be one or more of gold, silver, titanium, tungsten, platinum, cadmium, zinc, chromium, iron, carbon, molybdenum, lead, manganese, gallium, tin, tantalum, aluminum, nickel, cobalt, and alloys thereof. The insulating member can be one or more of alumina ceramic, lead zirconate titanate ceramics, silicon-nitride ceramics, zirconia ceramics, alumina-silicate ceramics, porcelain, glass, teflon, mica, boron nitride, polyethylene, nylon, polyurethane, silicon rubber, and lead borate. These dimensions and material selections are presented here as exemplary sizes and materials; therefore, it should be appreciated that other sizes and materials known to a person having ordinary skill in the art are also possible. The first and second electrically conducting members 102 104 were sanded with 600 grit sandpaper and the side on which the surface flashover events occur (i.e., the side bonded to the electrically insulating member 106) was additionally sanded using 514 grit diamond wheel.

Alumina ceramics was chosen as an exemplary material for the electrically insulating member 106 since it is characterized by the relatively low surface flashover breakdown voltages of about 5-10 kV/mm, since lower breakdown voltage is desirable, according to the teachings of the present disclosure. In addition, the insulator thickness was significantly reduced (down to <1 mm, and in particular to between about 1 0.5 mm) in comparison to that normally used in surface flashover studies of the prior art (>1 cm). As a result the break down voltage (V_{br}) was limited to the range of about 10-15 kV.

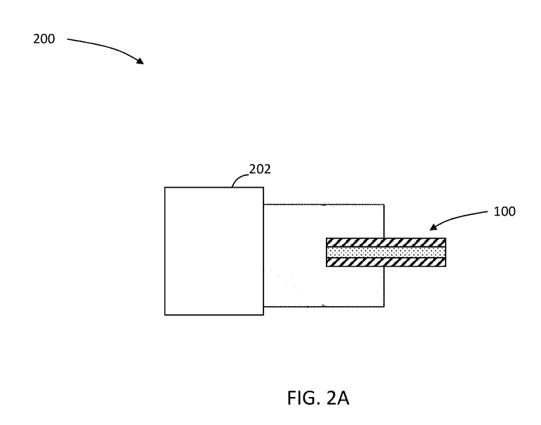

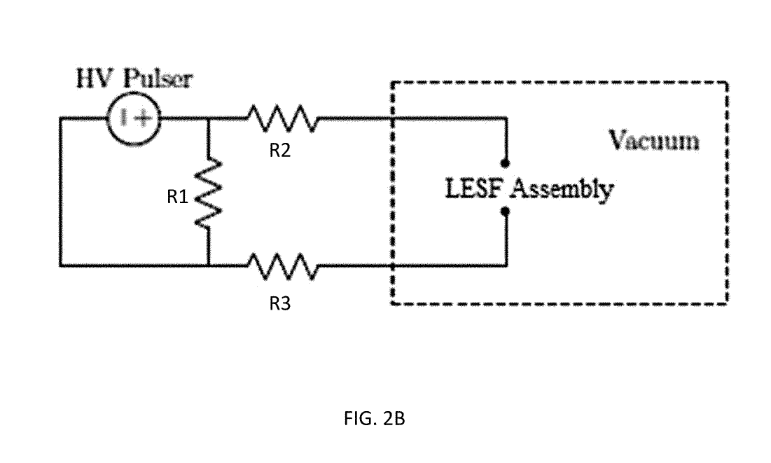

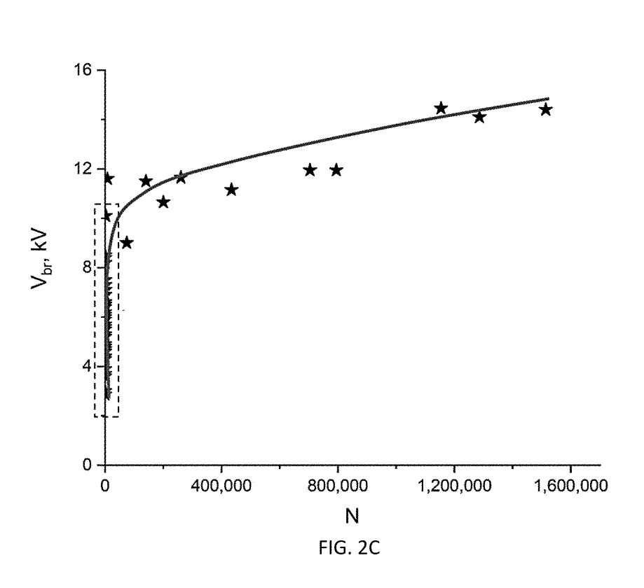

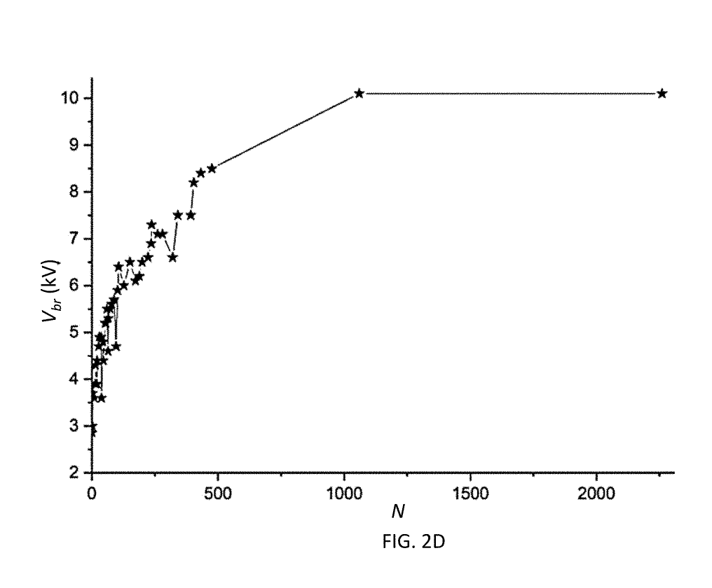

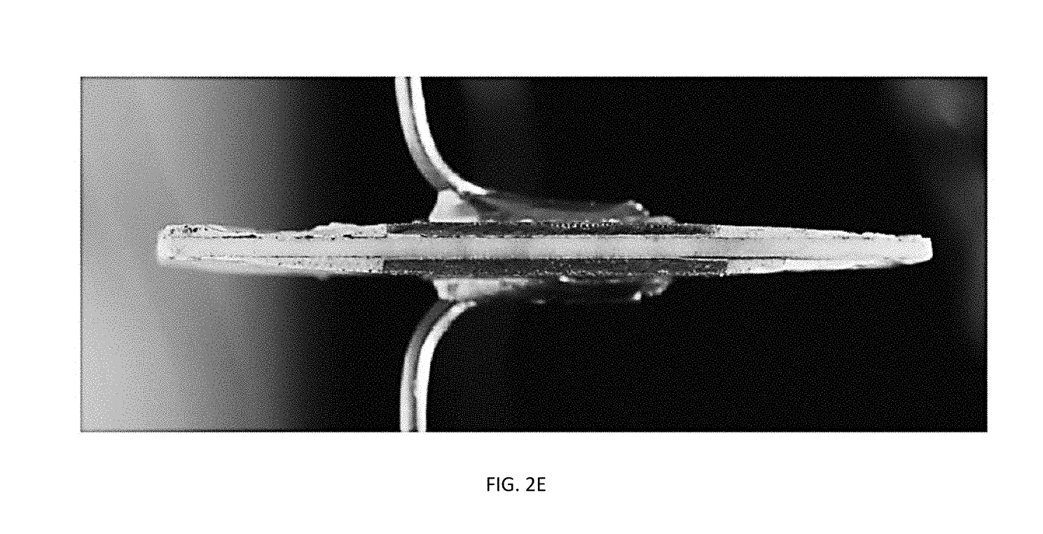

Referring to FIG. 2A, an excitation system 200 for excitation of the electrode assembly 100 is shown. The excitation system 200 includes an energy supply unit 202 coupled to the electrode assembly 100. In one embodiment the energy supply unit 202 can include energy storage units such as capacitors, inductors, etc. In another embodiment, the energy supply unit 202 can include two high voltage power supplies which can be used to initiate the surface flashover in the electrode assembly 100. An example of such power supply is EAGLE HARBOR NANOSECOND PULSER model NSP-3300-20-F (<110 ns, <20 kV) and BERTAN SERIES 225-20R DC power supply (<20 kV, <1 mA). A DC power supply SORENSON X60-28 (<60V, <28 A) was also used to provide the needed power for main discharge triggered by the flashover (further described below). Electric characteristics of the discharges were measured by TEKTRONIX P6015A passive high voltage probe, PEARSON 2100 and BERGOZ FCT-028-0.5-WB current monitors. Fast photographing of the surface flashover was captured by PRINCETON INSTRUMENTS PI-MAX4 ICCD camera.

Referring to FIG. 2B a schematic utilized in testing the flashover electrode assembly 100 of FIG. 1 is shown. A high voltage (HV) pulse generator is coupled to a resistive network and which is coupled to the electrode assembly 100 in vacuum. FIG. 2C is a graph of V_{br} vs. number of ignition cycles and which shows the voltage evolution of the required voltage to breakdown the flashover electrode assembly (V_{br}) in over 1.5·10⁶ flashover events (N). The EAGLE HARBOR PULSER was utilized with pulse amplitudes up to 15 kV and pulse duration of 110 ns in order to limit the duration of the high-current the third phase of the flashover associated with high-current arcing. These short flashover events with duration τ_{fl}≤100-200 ns are referred to as Low Energy Surface Flashover (LESF). During the first 500 initial pulses, the pulser was operated at single pulse mode, and then the pulse repetition rate was gradually increased from 1 to 200 Hz. A zoomed-in version of the graph shown in FIG. 2C for the first 2000 ignition cycles is shown in FIG. 2D.

It can be seen from FIG. 2C that the breakdown voltage increases rapidly from 2.9 kV during the first hundred pulses, followed by a leveling off as the curve approaches saturation in the range of 10-14 kV for N>1000. This initial increase of V_{br} is the effect of conditioning of the insulator surface which is associated with removal of surface gas, removal of surface contaminants, or removal of emission sites. Thereafter, V_{br} continues to increase slowly in the following flashover events (N>1000) where it reaches about 14.5 kV after about 10⁶ breakdowns. This nearly saturated region is associated with a fully conditioned sample.

It should be appreciated that the data presented in the FIG. 2C was obtained using the same electrode assembly which was run without failure or damage to the electrodes/insulator for more than 1,500,000 pulses. The photograph shown in FIG. 2E demonstrates that assembly after conducting over 1.5·10⁶ flashover events. Only minor ablation of the electrode assembly can be visually observed at the electrode-insulator interface. The continued health of the electrode assembly shown in FIG. 2E confirms that the approach of limiting the duration/energy of individual surface flashover event can ensure very long operational lifetime.

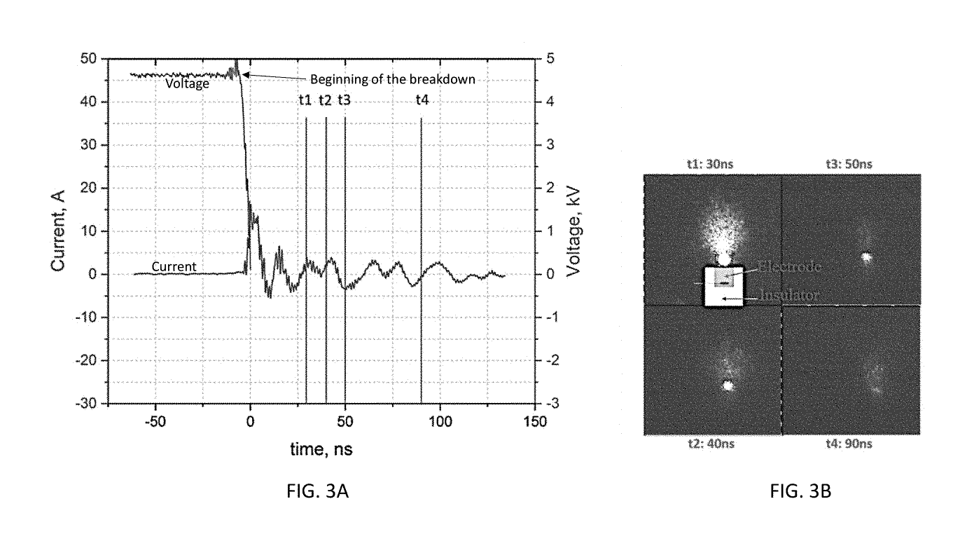

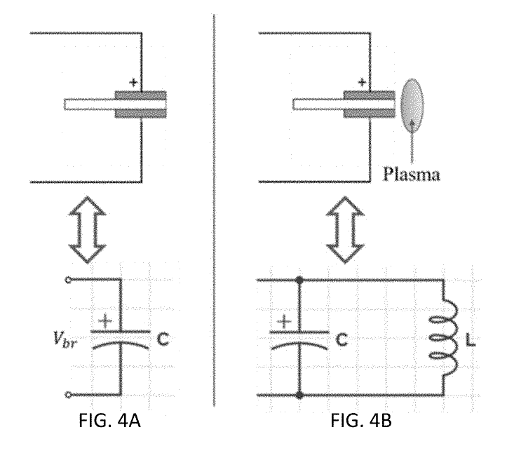

The plasma generation associated with a single flashover event is now described. Referring to FIG. 3A a complex graph of current measured in Ampere and voltage measured in kV is presented vs. time measured in ns. Four separate timelines are identified in FIG. 3A as t1, t2, t3, and t4. It can be appreciated that initiation of the flashover was indicated by an instant drop of voltage (near t≈0) and start of high frequency current oscillations. These current oscillations are associated with the resonant ringing in an LC circuit formed by the flashover assembly shortened by the plasma column. Schematic shown in FIGS. 4A and 4B represent lumped parameter representation of the LC circuit. Prior to the flashover, the electrode assembly is equivalent to a capacitor (C) charged to the voltage (V_{br}) as shown in the schematic of FIG. 4A. In one exemplary embodiment, the capacitance is 7 pF and thus resulting in total energy stored in the capacitor:

$$\frac{{CV}_{br}^{2}}{2}$$

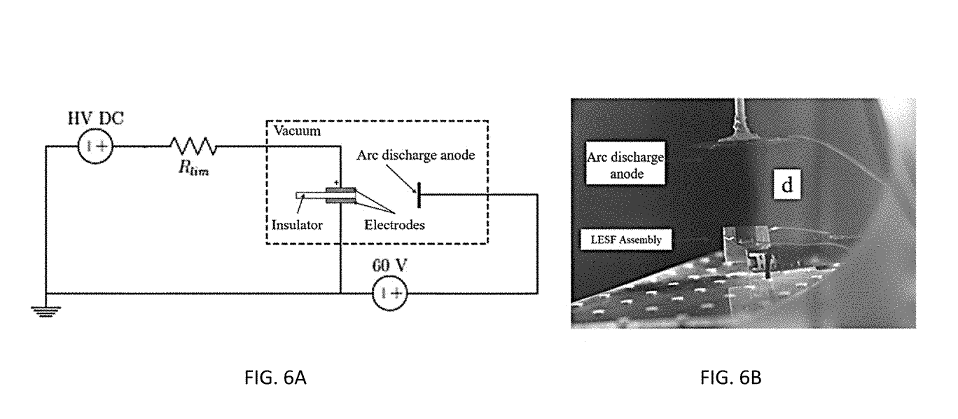

of equal to 0.07 mJ. Creation of the plasma in the flashover event causes immediate short of one side of the assembly by the generated plasma, while the other side of the assembly is nearly opened (see FIG. 4A). Since current replenishment through a large current limiting resistor coupled between the energy supply and the electrode assembly (see e.g., FIG. 6A, discussed below)—in one exemplary embodiment about 100 kΩ—is based on a timescale much larger than the flashover timescale (i.e., τ_{RC}=Rₗᵢₘ·C is much greater than τ_{fl}). Thus, total energy stored in the capacitor is oscillating between the open-ended capacitive side of the assembly and shortened by the plasmas inductive side of the assembly. The inductance of the shortened assembly is governed by the inductance of the leads. In one exemplary embodiment, the inductance is L_{w}=0.5 μH. It can be observed from FIG. 3A that period of the current oscillations is about 10-15 ns, which is consistent with the theoretical estimation for the resonant oscillation period in the LC-circuit: 2π\sqrt{L_{w}C}=12 ns.

The oscillations of the discharge current peaks at around 15 A around t≈0 and decayed on the time scale of about 50 ns as provided in FIG. 3A. The 4 timestamps (t1, t2, t3, and t4) correspond to photographs of plasma generation shown in FIG. 3B as τ_{fl} was evaluated by means of fast photographing conducted by ICCD camera. It should be noted that even though in the exemplary embodiment provided as shown in FIG. 6A, the electrode assembly was driven by a DC high voltage source, the duration of the flashover presented in the FIG. 3A and FIG. 3B was short (in the order of τ_{fl}<100 ns). Thus, the electrode assembly operated in the LESF mode.

Duration of the flashover event τ_{fl} driven by the circuitry shown in FIG. 6A can be controlled by adjusting the amount of initial energy stored in the flashover/leads assembly prior to the event

$${E}_{0} = \frac{{CV}_{br}^{2}}{2} \cdot {τ}_{fl}$$

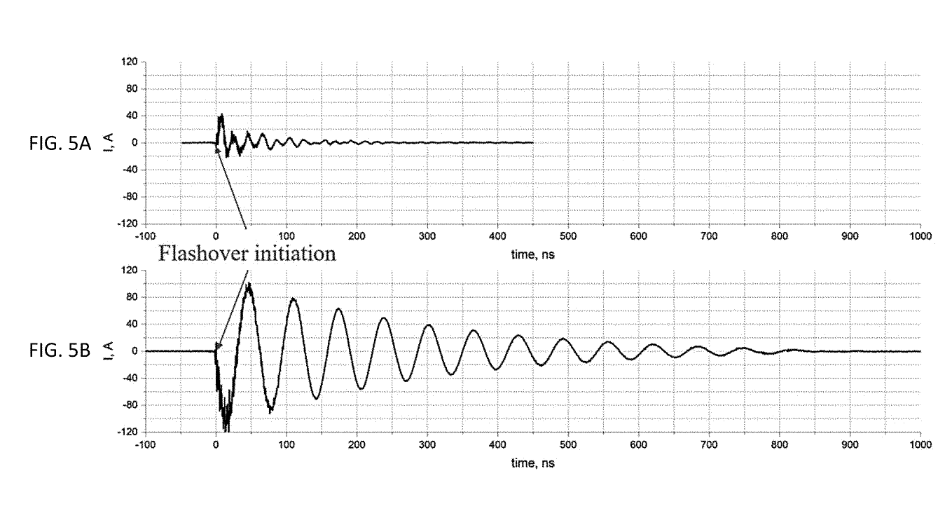

can be increased if larger energy E₀ is used, and since E₀ is proportional to C, a larger C represents a larger energy. To demonstrate this relationship, an additional capacitor (not shown) was inserted in parallel to the LESF electrode assembly to increase the capacitance and energy stored in the total capacitance prior to the flashover event. The tests were conducted with two capacitances C=7 and 100 pF and the corresponding initial energies stored in the assemblies were E₀=0.35 and 5 mJ, respectively (V_{br} was about 10 kV in both cases). Current waveforms for E₀=0.35 and 5 mJ are presented in FIGS. 5A and 5B, respectively. One can see that flashover duration τ_{fl} increased from about 50 ns to about 200 ns when initial energy E₀ increased from 0.35 to 5 mJ. In addition, the increase of capacitance to C=100 pF led to the corresponding increase of the oscillations' period to about 50 ns which is in agreement with the theoretical estimation 2π\sqrt{L_{w}C}=44 ns.

Next, the electrode assembly discussed herein is evaluated for the purpose of triggering the discharge in the electric propulsion system, according to the present disclosure. To this end, the LESF electrode assembly of the present disclosure was tested as an igniter in a current vacuum arc system. FIG. 6A shows a schematic of an assembly for testing the igniter. An additional anode was placed at the distance d from the LESF assembly as shown in the photograph of FIG. 6B. The anode was biased to a voltage of +60 VDC with respect to cathode of the flashover assembly as shown in FIG. 6B. The initial energy E₀ supplied to the flashover was varied by changing (reducing) the overall capacitance of the LESF assembly which is formed by connected in parallel capacitance of the flashover electrode assembly sandwich and capacitance of the leads.

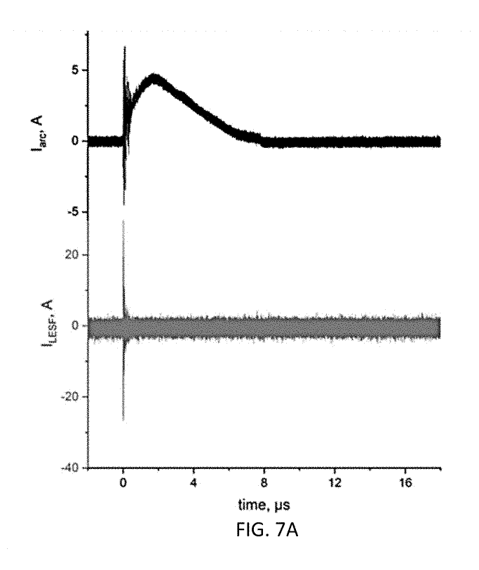

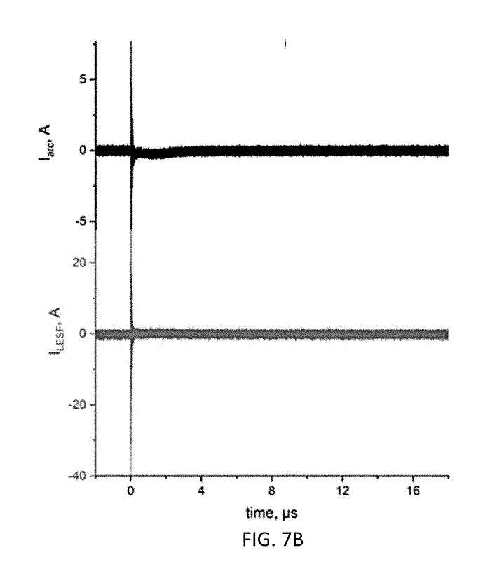

Different values of d was evaluated. For d=4 cm, a successful ignition of the arc discharge was observed with the initial energy E₀=0.73 mJ in 16 out of 20 trials, while E₀=0.39 mJ failed to ignite the arc. The successful initiation of the arc discharge is demonstrated by the arc current pulse of about I_{arc}=5 A lasting for about 8 μs as shown in the graph of current vs. time of FIG. 7A for d=4 cm. For d=2 cm, a successful ignition of the arc discharge was observed in every try with the initial energy E₀=0.73 mJ, while E₀=0.39 mJ led to the ignition of 4 out of 20 tries. The unsuccessful initiation for E₀=0.39 mJ is shown in FIG. 7B (a graph of current vs. time for d=4 cm). It can be inferred that seed plasma created by the LESF described herein is sufficient to trigger the arc discharge used in electric propulsion systems. In addition, closer proximity of the arc anode to the flashover assembly enhances the ignition due to higher density of the seed plasma in the gap. The current in FIGS. 7A and 7B identified as I_{arc} is through the second anode which signifies successful initiation of burning of the plasma in FIG. 7A and unsuccessful in FIG. 7B. In FIG. 7A, once the plasma begins to burn, it will continue to burn until electrode material is exhausted or voltage to the second anode is cut off.

The LESF electrode assembly system described here can be used to initiate discharge in Cathodic Arc Thrusters (CAT), Pulsed Plasma Thrusters (PPT) or other systems that may require reliable trigger. For CATs care should be given to positioning of the LESF assembly so as to avoid the direct exposure to the erosion products of the arc. In the LESF electrode system described herein operates based on high voltage pulses. These can be generated according to a number of approaches. For example a compact flyback transformer that requires low driving voltages of about 20-30 V can be used to eliminate the need for bulky high voltage capacitors. In addition, pulsing inductors can also be used to generate flyback kicks, in order to generate the high voltage needed, as known to a person having ordinary skill in the art.

Those having ordinary skill in the art will recognize that numerous modifications can be made to the specific implementations described above. The implementations should not be limited to the particular limitations described. Other implementations may be possible.

1. An ignitor subsystem for use in an electric propulsion system, comprising:
an igniter, comprising
a first electrically conducting electrode,
a second electrically conducting electrode, and
an electrically insulating layer sandwiched between the first and the second electrically conducting electrodes; and
a voltage pulse generator electrically coupled to the first and the second electrically conducting electrodes and adapted to generate a plurality of pulses each with sufficient voltage to cause a breakdown of the electrically insulating layer, thus causing an avalanche of electrons from one of the first and the second electrically conducting electrodes to the other, the voltage pulse generator further adapted to limit energy transferred to the igniter in each of the plurality of pulses so as to minimize damage to the igniter.

2. The igniter system of claim 1, wherein the first and the second electrically conducting electrodes are made from one or more of copper, gold, silver, titanium, tungsten, platinum, cadmium, zinc, chromium, iron, carbon, molybdenum, lead, manganese, gallium, tin, tantalum, aluminum, nickel, cobalt, and alloys thereof.

3. The igniter system of claim 1, wherein the electrically insulating layer is made from one of alumina ceramic, lead zirconate titanate ceramics, silicon-nitride ceramics, zirconia ceramics, alumina-silicate ceramics, porcelain, glass, teflon, mica, boron nitride, polyethylene, nylon, polyurethane, silicon rubber, and lead borate.

4. The igniter system of claim 1, wherein the voltage pulse generator limits the energy between 0.35 and 5 mJ.

5. The igniter system of claim 1, wherein the voltage pulse generator generates a voltage in the range of between 0 and 20 kV.

6. The igniter system of claim 1, wherein the voltage pulse generator uses an inductive flyback to generate the plurality of voltage pulses.

7. The igniter system of claim 1, wherein the voltage pulse generator uses a transformer secondary to generate the plurality of voltage pulses.

8. The igniter system of claim 1, wherein the voltage pulse generator uses a high voltage capacitor adapted to carry a voltage in the range of between 0 and 20 kV.

9. An electric propulsion system, comprising:
an igniter system, comprising
an igniter comprising
a first electrically conducting electrode,
a second electrically conducting electrode, and
an electrically insulating layer sandwiched between the first and the second electrically conducting electrodes, and
a voltage pulse generator electrically coupled to the first and the second electrically conducting electrodes and adapted to generate a plurality of pulses each with sufficient voltage to cause a breakdown of the electrically insulating layer, thus causing an avalanche of electrons from one of the first and the second electrically conducting electrodes to the other thereby generating a cloud of plasma near the igniter, the voltage pulse generator further adapted to limit energy transferred to the igniter in each of the plurality of pulses so as to minimize damage to the igniter; and
a burner disposed to receive and ignite the cloud of plasma and eject the burned plasma at high rate of speed out of the burner.

10. The electric propulsion system of claim 8, wherein the first and the second electrically conducting electrodes are made from one or more of wherein the first and the second electrically conducting electrodes are made from one or more of copper, gold, silver, titanium, tungsten, platinum, cadmium, zinc, chromium, iron, carbon, molybdenum, lead, manganese, gallium, tin, tantalum, aluminum, nickel, cobalt, and alloys thereof.

11. The electric propulsion system of claim 8, wherein the electrically insulating layer is made from one of wherein the electrically insulating layer is made from one of alumina ceramic, lead zirconate titanate ceramics, silicon-nitride ceramics, zirconia ceramics, alumina-silicate ceramics, porcelain, glass, teflon, mica, boron nitride, polyethylene, nylon, polyurethane, silicon rubber, and lead borate.

12. The electric propulsion system of claim 8, wherein the voltage pulse generator limits the energy between 0.35 and 5 mJ.

13. The electric propulsion system of claim 8, wherein the voltage pulse generator generates a voltage in the range of between 0 and 20 kV.

14. The electric propulsion system of claim 8, wherein the voltage pulse generator uses an inductive flyback to generate the plurality of voltage pulses.

15. The electric propulsion system of claim 8, wherein the voltage pulse generator uses a transformer secondary to generate the plurality of voltage pulses.

16. The igniter system of claim 1, wherein the voltage pulse generator uses a high voltage capacitor carrying the voltage in the range of between 0 and 20 kV.

17. A method of generating plasma for an electric propulsion system, comprising:
providing a plurality of voltage pulses to an igniter by a voltage pulse generator, the igniter comprising
a first electrically conducting electrode,
a second electrically conducting electrode, and
an electrically insulating layer sandwiched between the first and the second electrically conducting electrodes; and
wherein the voltage pulse generator electrically coupled to the first and the second electrically conducting electrodes and adapted to generate a plurality of pulses each with sufficient voltage to cause a breakdown of the electrically insulating layer, thus causing an avalanche of electrons from one of the first and the second electrically conducting electrodes to the other, the voltage pulse generator further adapted to limit energy transferred to the igniter in each of the plurality of pulses so as to minimize damage to the igniter.

18. The method of claim 15, wherein the first and the second electrically conducting electrodes are made from one or more of wherein the first and the second electrically conducting electrodes are made from one or more of copper, gold, silver, titanium, tungsten, platinum, cadmium, zinc, chromium, iron, carbon, molybdenum, lead, manganese, gallium, tin, tantalum, aluminum, nickel, cobalt, and alloys thereof.

19. The method of claim 15, wherein the electrically insulating layer is made from one of alumina ceramic, lead zirconate titanate ceramics, silicon-nitride ceramics, zirconia ceramics, alumina-silicate ceramics, porcelain, glass, teflon, mica, boron nitride, polyethylene, nylon, polyurethane, silicon rubber, and lead borate.

20. The method of claim 15, wherein the voltage pulse generator limits the energy between 0.35 and 5 mJ.

21. The method of claim 15, wherein the voltage pulse generator generates a voltage in the range of between 0 and 20 kV.

22. The method of claim 15, wherein the voltage pulse generator uses one or more of an inductive flyback to generate and a transformer secondary to generate the plurality of voltage pulses.
